(19) United States
(12) Patent Application Publication
(10) Pub. No.: US 2009/0231619 A1
(43) Pub. Date: Sep. 17, 2009

(54) System, Apparatus, and Method for Outputting Authentication Job

(75) Inventor: Yusuke Takahashi, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/403,149

(22) Filed: Mar. 12, 2009

(30) Foreign Application Priority Data
Mar. 13, 2008 (JP) 2008-063630

(51) Int. Cl. G06F 3/12

(52) U.S. Cl. 358/1.15

(57) ABSTRACT

An authentication output apparatus, connected to a job storage device for communication, performs an output operation for outputting an authentication output job and a standard output job. The job storage device stores the authentication output job. The authentication output apparatus performs the output operation by reading from the job storage device the authentication output job relating to a user upon the user being authenticated. The authentication output includes a job receiver that receives the standard output job, a job transferring unit that transfers the received standard output job to the job storage device, an output instruction unit that reads from the job storage device the standard output job related to the user upon the user being authenticated, and an output executing unit that performs the output operation to output the read standard output job.

### BACKGROUND

1. Technical Field

The present invention relates to a system, an apparatus and a method for performing an output operation of an authentication output job and a standard output job, such as print outputting, mail transmission, and facsimile transmission.

2. Related Art

Japanese Patent No. 3034160 discloses an authentication print system that temporarily suspends a print job received from a user, and then executes the print job upon the user being authenticated. Some multi-purpose apparatuses have a plurality of functions including a printing function, an image scanning function, an electronic mail function, and a facsimile communication function. Such a multi-purpose apparatus allows each of the plurality of functions including the printing function, the image scanning function, the electronic mail function, the facsimile communication function and data storage to a folder to be operated only when the user is successfully authenticated.

Such an authentication output system handles not only an “authentication output job” that is operative only when authentication has been successfully completed but also a “standard output job” that is operative without the need for authentication. In many authentication output systems, a selection as to whether a given job is to be handled as the authentication output job or the standard output job is left to the responsibility of a user. For example, in a typical printing system, a printer driver displays on a graphic user interface (GUI) a switch (a button or an icon) to prompt a user to select between an “authentication print” and a “standard print.” The user thus selects one of an authentication print job and a standard print job by clicking the switch.

When a secret document is to be printed, the user naturally selects the authentication output job. If the user erroneously selects the standard output job, a printed secret document as a result of printing can be disclosed to or even carried away by another person. As a result, there is a risk that the secret information leaks.

### SUMMARY

An advantage of some aspects of the invention is that security of information is assured even if the user mistakenly selects the standard output job for the authentication output job.

In accordance with one embodiment of the invention, an authentication output apparatus receives a standard output job, regards the standard output job as an authentication output job, suspends an output operation of the standard output job, transfers the received job to a job storage device to store the received job on the job storage device, and then performs the output operation of the received job upon the user being authenticated. All the received standard output jobs may be handled as an authentication output job. Alternatively, a predetermined determination operation may be performed to determine whether to handle the received job as an authentication output job or a standard output job.

In accordance with one aspect of the invention, an authentication output apparatus, connected to a job storage device for communication, performs an output operation for outputting an authentication output job and a standard output job. The job storage device stores the authentication output job. The authentication output apparatus performs the output operation by reading from the job storage device the authentication output job relating to a user upon the user being authenticated. The authentication output apparatus includes a job receiver that receives the standard output job, a job transferring unit that transfers the received standard output job to the job storage device, an output instruction unit that reads from the job storage device the standard output job related to the user upon the user being authenticated, and an output executing unit that performs the output operation to output the read standard output job.

The authentication output apparatus handles the received standard output job as an authentication output job. The output operation is thus performed (typically in front of the user) only if the user is authenticated. This arrangement reduces the possibility of information leaks from the results of the output process.

When the standard output job is received, the authentication output apparatus determines whether at least one condition is satisfied, and, in response to the determination results, selects between supplying the received standard output job to the job transferring unit to transfer the received standard output job to the job storage device and supplying the received standard output job to the output executing unit to perform the output operation.

The authentication output apparatus may have a function of detecting a second job storage device, and then transferring the received standard output job to the second job storage device if the attempt to transfer the received standard output job to the first job storage device is unsuccessful.

With the predetermined condition set up, any job in need of information leak protection out of the received standard output jobs is selectively handled as an authentication output job. More specifically, even if the user erroneously selects the standard output job, the output operation is suspended in an information protective fashion until a successful user authentication. If the user correctly selects the standard output job, the output operation is immediately performed in a convenient fashion. The information protection and the operation convenience are thus properly harmonized.

A plurality of methods of determining whether the condition is satisfied are available selectively or in combination as described below.

In one determination method, identification information regarding a transmission source device having transmitted the received standard output job is acquired, and it is then determined based on the identification information whether the predetermined condition is satisfied. The identification information of the transmission source device may be an network address such as an Internet protocol (IP) address. It is then determined whether the address of the transmission source device is within a predetermined network segment (for example, within the same network segment as that of the authentication output apparatus). In response to the determination results, for example, if the transmission source device is within a network segment different from that of the authentication output apparatus, the user may be present in a place remote from the authentication output apparatus, and the received standard output job is handled as an authentication output job.

In another determination method, it is determined whether the authentication output apparatus is provided with a keyed bin for a printed matter output related to a print job in particular. It is further determined whether the printed matter output keyed bin is empty or not. If the determination results show that the printed matter output key bit is provided and is empty, the possibility that the resulting printed matter is watched by another person is extremely low. The received standard output job is handled as a standard output job as is. If the determination results show that the printed matter output keyed bin is not provided, the received standard output job may be handled as an authentication output job.

In yet another determination method, the authentication output apparatus pre-stores at least one piece of particular character information or one piece of particular image information, extracts character information or image information contained in an output image of the received standard output job, and determines in one of the predetermined conditions whether the extracted character information or the extracted image information corresponds to the pre-stored particular character information or the pre-stored particular image information. If the output image contains information matching the particular character information or the particular image information, the standard output job is handled as an authentication output job.

In still another determination method, the authentication output apparatus acquires position information of the transmission source device of the received standard output job, and, based on the acquired position information, determines in one of the predetermined conditions whether the position of the transmission source device is within a predetermined positional area. For example, if the transmission source device is spaced from the authentication output apparatus by a predetermined distance or longer, the standard output job is handled as an authentication output job.

In still another determination method, the authentication output apparatus acquires attribute information of the received standard output job, and determines based on the acquired attribute information whether the predetermined condition is satisfied. The attribute information may contain a variety of items such as a file name, an indication of whether output form encryption is specified, an indication of whether watermark insertion is specified, time and date of transmission (for example, time and date outside office hours).

In a specific method of using the job attribute, the authentication output apparatus pre-stores at least one piece of particular attribute information, and determines in one of the predetermined conditions whether the acquired attribute information corresponds to any of the pre-stored particular attribute information. For example, if the output encryption is specified, if an insertion of a particular word such as “Confidential” or a watermark is specified, or if time and date other than the office hours is detected, the standard output job is handled as an authentication output job.

In another specific method of using the job attribute, the authentication output apparatus stores a history of attribute information of a past authentication output job and a past standard output job handled as an authentication output job, and checks the acquired attribute information against the attribute information within the stored history in order to determine whether the predetermined condition is satisfied. If the attribute information of the presently received standard output job partially matches the attribute information within the history, the presently received standard output job is handled as an authentication output job. If a plurality of authentication output apparatuses are present, one apparatus may perform this method by referencing the history thereof, or by accessing not only the history thereof but also a history of another apparatus. Alternatively, a server storing the history is arranged and the apparatus performs the same method by accessing the history of the server.

In still another determination method, the authentication output apparatus determines whether the user authentication function to be performed on the standard output job is effective (for example, as to whether a removable device for inputting authentication information is mounted or as to how user authentication is set in operation environment setting). If the user authentication function is effective, all the standard output jobs are handled as authentication output jobs.

If the received standard output job is to be handled as an authentication output job, the authentication output apparatus may request the transmission source device of the standard output job to modify the setting of the standard output job and the authentication output job to select the authentication output job. In this way, the user is notified of a selection error at the job transmission source device, and a subsequent selection error is avoided by modifying the setting.

Upon failing to transfer the received standard output job to the job storage device, the authentication output apparatus detects a second job storage device, and then transfers the received standard output job to the second job storage device.

In accordance with another aspect of the invention, an authentication output system includes the authentication output apparatus, the job storage device, and the job transmission source device.

In accordance with another aspect of the invention, a method of processing the authentication output job and the standard output job performed by the above-described authentication output apparatus and authentication output system is provided.

In accordance with embodiments of the invention, the information security level of the authentication output job the user has mistakenly selected for the standard output job is increased.

### BRIEF DESCRIPTION OF THE DRAWINGS

The invention will be described with reference to the accompanying drawings, wherein like numbers reference like elements.

FIG. 1 is a functional block diagram illustrating generally an authentication printing system in accordance with one embodiment of the invention.

FIG. 2 diagrammatically illustrates a system configuration of the system illustrated in FIG. 1.

FIG. 3 is a flowchart of a process performed when a client issues an instruction of a standard print job.

FIG. 4 is a flowchart of an authentication process performed by a printer.

FIG. 5 is a flowchart illustrating a process in which the client generates and transmits a print job.

FIG. 6 is a flowchart illustrating a process in which the a spool server receives and stores the print job.

FIG. 7 is a flowchart illustrating an authentication print process performed by the printer.

FIG. 8 is a flowchart of a print job reception of the printer.

FIG. 9 illustrates an IP address (identification information) of the client (job transmission source).

FIG. 10 illustrates an installation location of the client (job transmission source).

FIG. 11 illustrates attribute information of the print job.

### DESCRIPTION OF EXEMPLARY EMBODIMENTS

With reference to the drawings, one embodiment of the invention is described below. In the following discussion of the embodiment, all the jobs handled are referred to as “print jobs” for print outputting. The print job is described for exemplary purposes only. The scope of the invention is limited to an objective of each job. For example, the jobs include but are not limited to print outputting, mail transmission, facsimile transmission, and data storage to a folder.

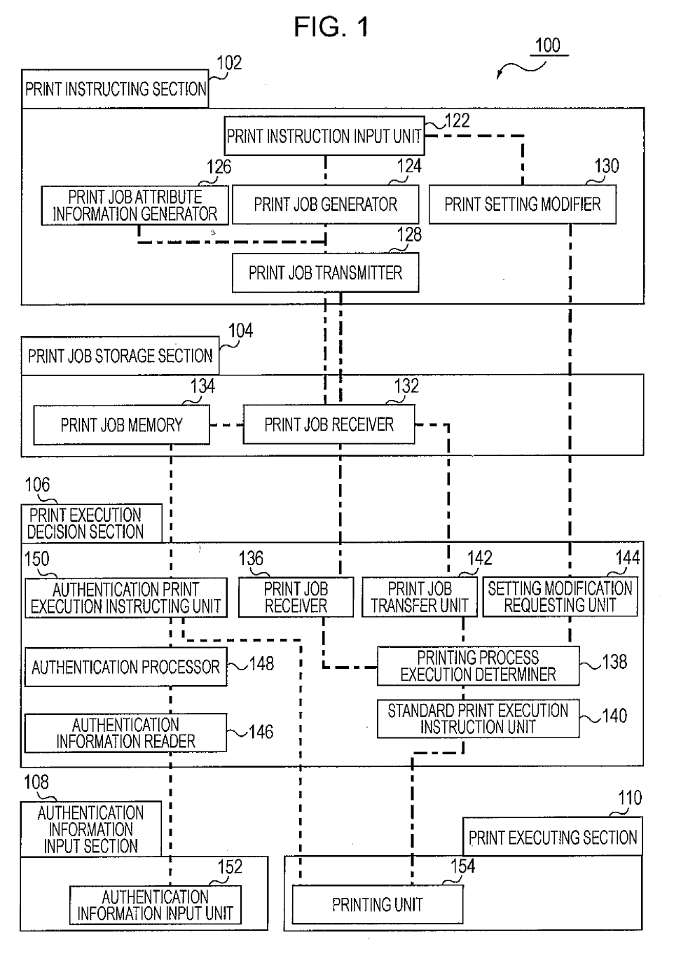

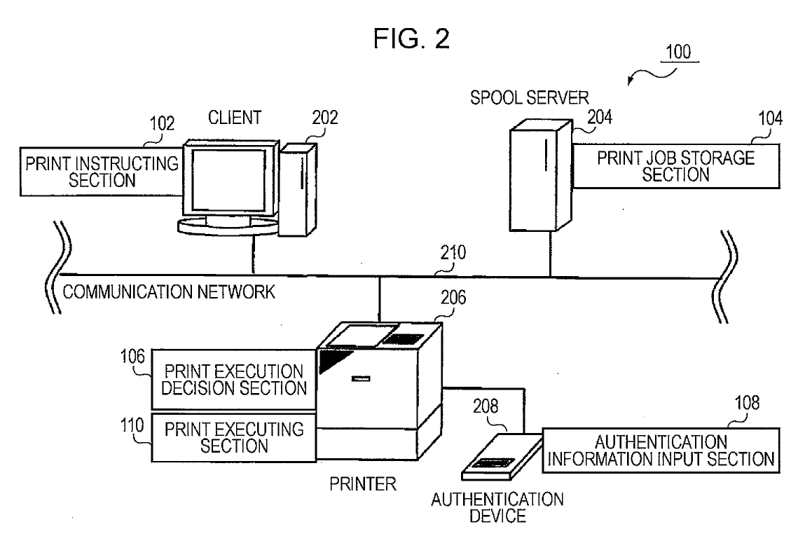

FIG. 1 is a functional block diagram illustrating generally an authentication printing system 100 in accordance with the embodiment of the invention. FIG. 2 illustrates a configuration of the system of FIG. 1.

With reference to FIG. 1, the authentication printing system 100 includes a print instructing section 102, a print job storage section 104, a print execution decision section 106, an authentication information input section 108, and a print executing section 110.

Referring to FIG. 2, the authentication printing system 100 includes a client 202, for example, composed of a personal computer, a spool server 204, for example, composed of a personal computer, and a printer 206 connected to the spool server 204 in a communicable fashion. The printer 206 includes an authentication device 202. In this case, the authentication device 208 may be contained in the printer 206 or may be external to and connected to the printer 206. Alternatively, instead of directly being connected to the printer 206, the authentication device 208 may be arranged on one of the client 202 and the spool server 204. The client 202, the spool server 204, and the printer 206 are interconnected to each other via a communication network 210 in a communicable fashion. One client 202, one spool server 204, and one printer 206 are illustrated here, but each of these elements may be employed in plural number of units.

The client 202 illustrated in FIG. 2 includes the print instructing section 102 illustrated in FIG. 1. The spool server 204 illustrated in FIG. 2 includes the print job storage section 104. The printer 206 illustrated in FIG. 2 includes the print execution decision section 106 and the print executing section 110, illustrated in FIG. 1. The authentication device 208 illustrated in FIG. 2 includes the authentication information input section 108 illustrated in FIG. 1. The relationship between the hardware elements illustrated in FIG. 2 and the functions illustrated in FIG. 1 is one example only, and another relationship is perfectly acceptable.

The structure of the authentication printing system 100 is described in detail with reference to FIG. 1.

Referring to FIG. 1, the print instructing section 102 has a function of generating and transmitting a print job. The print jobs transmitted from the print instructing section 102 includes two types of print jobs, namely, an authentication print job and a standard print job. The authentication print job is a print job the print instructing section 102 designates as the one to be printed out on condition that the user has been successfully authenticated. The standard print job remains unrelated to the user authentication and is a print job the print instructing section 102 designates as the one to printed out immediately subsequent to the transmission of the print job from the print instructing section 102.

In accordance with the present embodiment, the print instructing section 102 transmits the authentication print job to the print job storage section 104 while transmitting the standard print job to the print execution decision section 106. In other words, the print job transmitted from the print instructing section 102 to the print job storage section 104 in the authentication printing system 100 is an authentication print job. The print job transmitted from the print instructing section 102 to the print execution decision section 106 is a standard print job. The authentication print job and the standard print job are different in destination in this way. This arrangement is one example only. Alternatively, both the authentication print job and the standard print job may be transmitted to the print job storage section 104 as a common destination or to the print execution decision section 106 as a common destination.

The print job storage section 104 has a function of storing the authentication print job from the print instructing section 102 until a print output operation of the authentication print job is allowed. The print job storage section 104 also has a function of storing the standard print job transferred from the print execution decision section 106 until a print output operation of the standard print job is allowed.

The print execution decision section 106 determines whether to execute the print output operation of the standard print job received from the print instructing section 102. If it is determined that the print output operation is to be executed, the print execution decision section 106 supplies the standard print job to the print executing section 110 (in other words, the standard print job is handled as is). On the other hand, if it is determined that the print output operation is not to be executed, the print execution decision section 106 transmits the standard print job to the print job storage section 104 (in other words, the standard print job is handled as an authentication print job). The print execution decision section 106 also receives authentication information of a user from the authentication information input section 108, reads from the print job storage section 104 the print job responsive to the authentication information (the authentication print job or the standard print job handled as an authentication print job), and supplies the read print job to the print executing section 110.

The authentication information input section 108 has a function of receiving the authentication information of the user and supplying the received authentication information to the print execution decision section 106.

The print executing section 110 has a function of executing the print output operation of the print job supplied from the print execution decision section 106.

The elements of the system are described in detail below.

The print instructing section 102 includes a print instruction input unit 122, a print job generator 124, a print job attribute information generator 126, a print job transmitter 128, and a print setting modifier 130.

The print instruction input unit 122 issues an instruction to generate the print job as one of the authentication print job and the standard print job in accordance with a user instruction input or a setting input beforehand.

The print job generator 124 generates one of the authentication print job and the standard print job in response to the instruction from the print instruction input unit 122.

The print job attribute information generator 126 generates attribute information, such as a user ID, a document name, a print data encryption instruction, a print watermark instruction, and/or time and date of printing, in response to the user instruction input or the setting input beforehand. The print job attribute information generator 126 adds or embeds the attribute information to the print job generated in the print job generator 124.

The print job transmitter 128 transmits the generated print job to one of the print job storage section 104 and the print execution decision section 106. The print job generated as an authentication print job is transmitted to the print job storage section 104 and the print job generated as a standard print job is transmitted to the print execution decision section 106.

The print setting modifier 130 receives a request to modify print setting transmitted from the print execution decision section 106 and displays the request to the user.

The print job-storage section 104 includes a print job receiver 132 and a print job memory 134.

The print job receiver 132 receives the authentication print job from the print instructing section 102. The print job receiver 132 also receives the standard print job from the print execution decision section 106 (that standard print job is handled as an authentication print job hereinafter).

The print job memory 134 stores the print job received by the print job receiver 132 (i.e., the authentication print job, or the standard print job handled as an authentication print job).

The print execution decision section 106 includes a print job receiver 136, a print process execution determiner 138, a standard print execution instruction unit 140, a print job transfer unit 142, a setting modification requesting unit 144, an authentication information reader 146, an authentication processor 148, and an authentication print execution instructing unit 150.

The print job receiver 136 receives the standard print job from the print instructing section 102.

The print process execution determiner 138 determines whether at least one condition is satisfied. In response to the determination results, the print process execution determiner 138 determines whether to execute the print output operation of the standard print job received by the print job receiver 136 as is (i.e., without acquiring user authentication). If it is determined that the print output operation is to be executed, the print process execution determiner 138 supplies the standard print job to the standard print execution instruction unit 140. If it is determined that the print output operation is not to be executed, the print process execution determiner 138 supplies the standard print job to the print job transfer unit 142.

The standard print execution instruction unit 140 requests the print executing section 110 to execute the print output operation of the standard print job.

The print job transfer unit 142 transmits the supplied standard print job to the print job storage section 104 (to handle the standard print job as an authentication print job hereinafter).

When the standard print job is transmitted from the print job transfer unit 142 to the print job storage section 104, the setting modification requesting unit 144 transmits to the print instructing section 102 a request to modify print setting heretofore set in the print instructing section 102. For example, the request is to modify the print setting from the one to generate mainly a standard print job to the one to generate mainly an authentication print job.

The authentication information reader 146 receives the authentication information of the user input on the authentication information input section 108 and supplies the received authentication information to the authentication processor 148.

The authentication processor 148 performs an authentication process based on the authentication information of the user (to verify that user identification data contained in the authentication information is true or false). If the authentication process has been successfully completed (i.e., if the user identification data is verified to be true), the authentication information is then supplied to the authentication print execution instructing unit 150.

The authentication print execution instructing unit 150 reads from the print job memory 134 the print job of the user identified by the received authentication information, and then transmits the print job to the print executing section 110.

The authentication information input section 108, including an authentication information input unit 152, receives the authentication information of the user via the authentication information input unit 152. For example, the authentication information input unit 152 receives a manually input user ID or a manually input password, reads the user ID or the password from a memory card, or reads biometric information such as a fingerprint of the user.

The print executing section 110 includes a printing unit 154. The printing unit 154 executes the print output operation of the standard print job. The authentication information input unit 152 executes the print output operation of the authentication print jobs (including the standard print job handled as an authentication print job) supplied from the authentication print execution instructing unit 150.

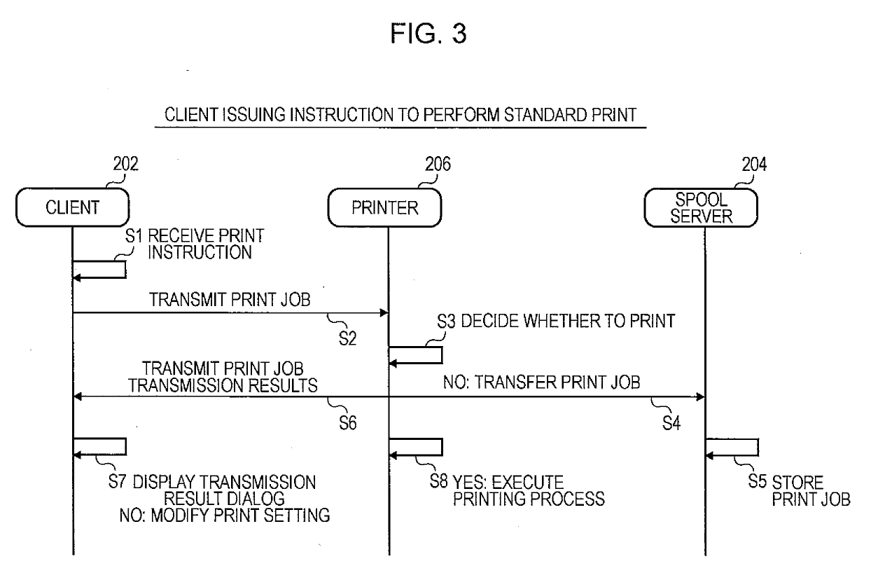

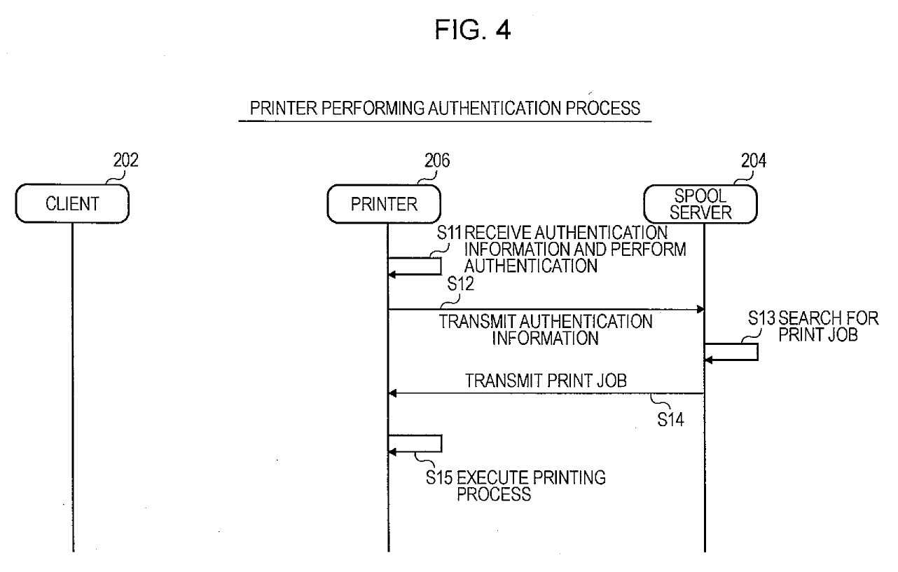

Referring to FIGS. 3 and 4, operation of the authentication printing system 100 thus constructed is described below.

FIG. 3 is a flowchart illustrating a process performed when the client 202 issues an instruction to output the standard print job.

The client 202 inputs a print instruction to print the standard print job (S1). In response to the instruction, the standard print job is transmitted from the client 202 to the printer 206 (S2). The print process execution determiner 138 in the printer 206 determines whether to perform the printing process of the received standard print job (S3).

If it is determined in step S3 that the printing process is to not to be executed, the printer 206 transmits the standard print job to the spool server 204 (S4), and the spool server 204 stores the received print job (S5). The standard print job is handled as an authentication print job hereinafter. A plurality of spool servers 204 may be employed. In such a case, if the printer 206 fails to transmit the standard print job to one spool server 204, the printer 206 attempts to detect another spool server 204. If another spool server 204 is detected, the printer 206 may transmit the standard print job to the detected spool server 204.

After transmitting the standard print job to the spool server 204, the printer 206 transmits transmission results of the standard print job to the client 202 (S6). Upon receiving the print job transmission results, the client 202 displays the results on a transmission result dialog (S7). The transmission results of the standard print job contain the above-described setting modification request. Referencing the displayed setting modification request, the user can modify the print setting of the client 202 to a more appropriate one.

If the printer 206 determines in step S3 that the print process is to be executed, the standard print job is printed as is (S8).

FIG. 4 is a flowchart illustrating an authentication process of the printer 206.

The printer 206 includes the authentication information input section 108. When the authentication information of the user is input to the authentication information input section 108, the authentication process is initiated (S11). If the authentication process is successfully completed, the printer 206 transmits the authentication information to the spool server 204 (S12) (alternatively, the printer 206 requests a print job of the user identified by the authentication information).

The spool server 204 searches for the print job of the user identified by the authentication information (S13), and transmits the hit print job to the printer 206 (S14). The printer 206 executes the printing process of the print job read from the spool server 204 (S15).

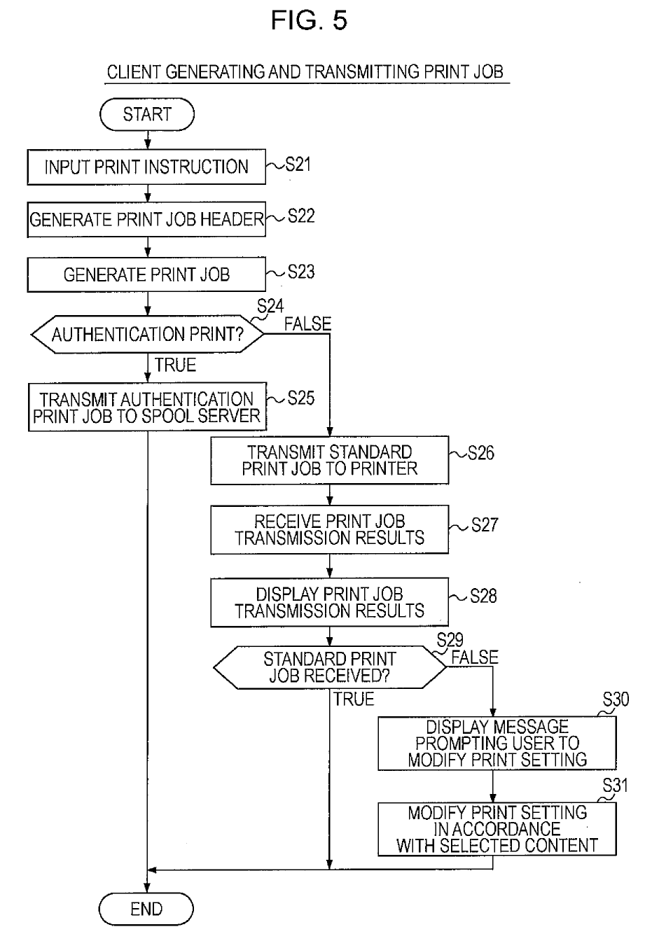

Each process of the elements of the authentication printing system 100 in accordance with the present embodiment is described below with reference to FIGS. 5-8.

FIG. 5 is a flowchart illustrating a process of the client 202 that generates and then transmits the print job.

When the user inputs a print instruction (S21), a print job header is generated (S22). The attribute information, such as a user ID, a document name, a print data encryption instruction, a print watermark instruction, and/or time and date of printing, is written on the print job header. Print data representing an image to be printed is generated. The print data and the print job header form a print job (S23).

In response to the print setting or the print instruction, the client 202 determines whether the generated print job is an authentication print job or a standard print job (S24). If the print job is the authentication print job, the authentication print job is transmitted to the spool server 204 (S25), and processing thus ends.

If the generated print job is a standard print job, the client 202 transmits the standard print job to the printer 206 (S26). The client 202 receives from the printer 206 the transmission results of the standard print job (S27), and then displays the transmission results to the user (S28).

The transmission results displayed to the user indicate that the standard print job has been normally received (True in S29), the printer 206 ends the process.

On the other hand, if the transmission results indicate that the standard print job has been handled as an authentication print job (has been transmitted to the spool server 204), in other words, if the transmission results contain a setting modification request to the print job (False in S29), a message prompting the user to modify the print setting is displayed (S30). Referencing the message, the user can select a new setting for modifying the print setting (S31).

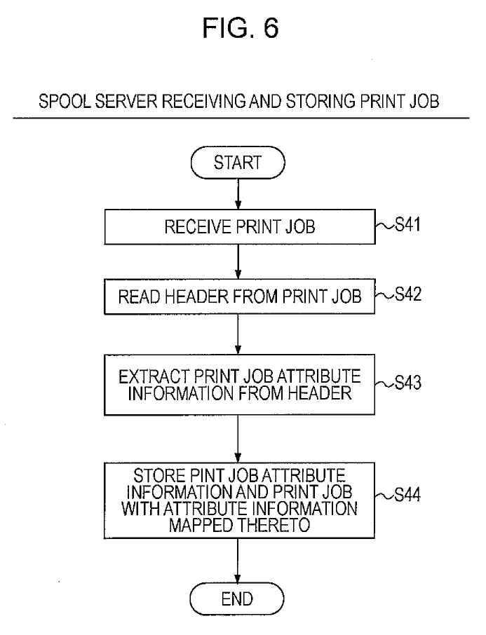

FIG. 6 is a flowchart illustrating a process of the spool server 204 that receives and stores the print job.

The spool server 204 receives from the client 202 the authentication print job, and from the printer 206 the standard print job (to be handled as an authentication print job) (S41).

The spool server 204 receives the print job header from the received print job (S42), and extracts the print job attribute information from the header (S43). The spool server 204 then stores the print job attribute information and the print job with the print job attribute information mapped thereto (S44). Processing thus ends.

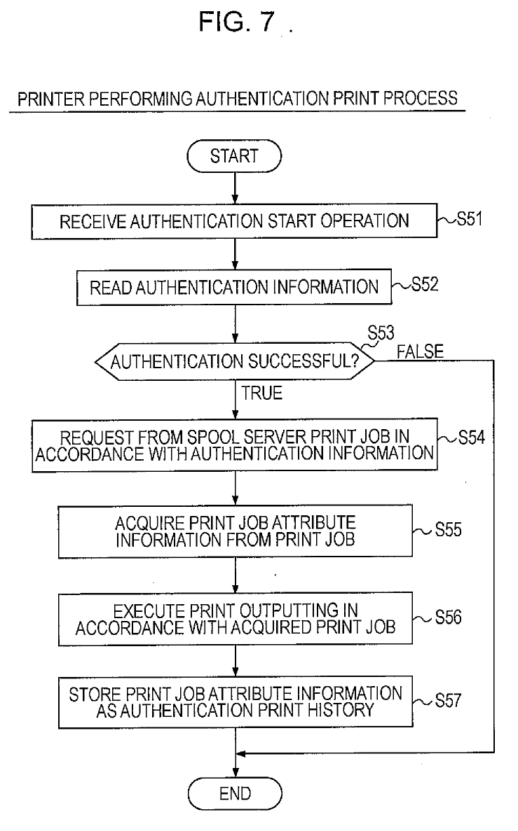

FIG. 7 is a flowchart illustrating the authentication print jobs (including the standard print job handled as an authentication print job) to be executed by the printer 206.

When the authentication information input unit 152 in the printer 206 receives an authentication start operation (input operation of the authentication information) (S51), the authentication information reader 146 acquires the authentication information (S52). The authentication processor 148 performs the authentication process using the authentication information (S53). If the authentication process has failed, processing ends. If the authentication process has completed successfully, the printer 206 requests the print job from the spool server 204 in response to the authentication information (S54).

The printer 206 acquires the attribute information written on the job header from the print job received from the spool server 204 (S55), and executes the print output operation in response to the acquired print job (S56). The printer 206 stores the print job attribute information as a history of the authentication print job (S57), and ends the process.

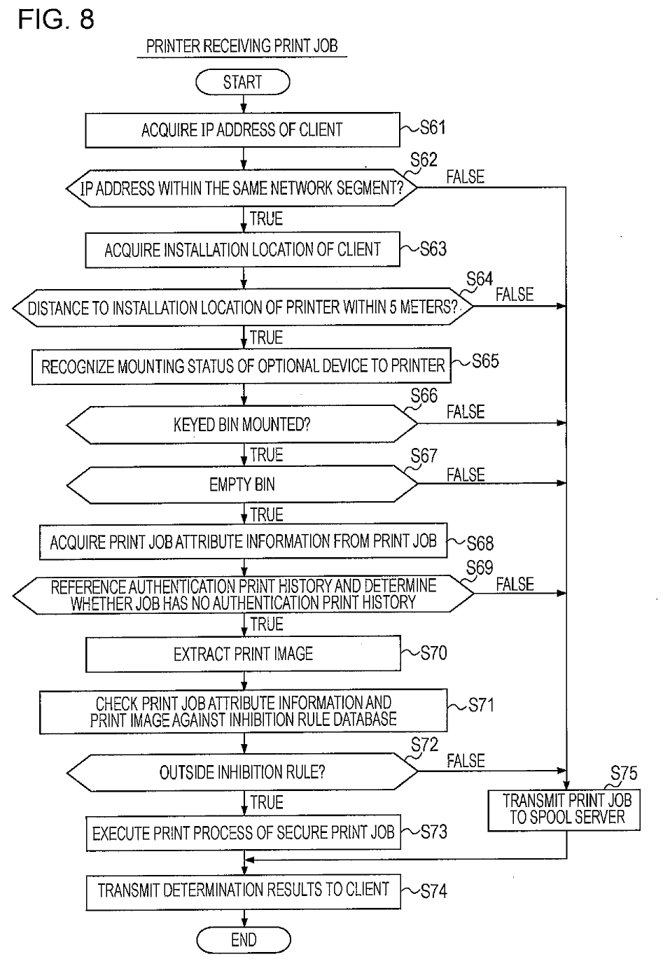

FIG. 8 illustrates a process of the printer 206 that receives the standard print job.

The print execution decision section 106 in the printer 206 determines whether to perform the print output operation of the received standard print job in a procedure described below.

The print execution decision section 106 acquires the identification information, such as an IP address, of the client 202 as a job transmission source of the standard print job (S61), and then determines whether that IP address is an IP address within the same network segment as that of the printer 206 (S62).

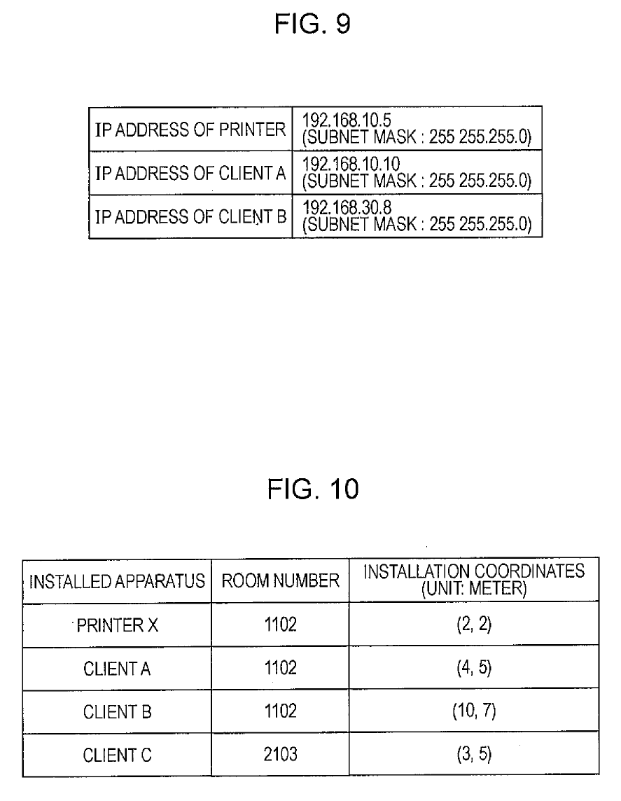

A determination process of the IP address is described below with reference to FIG. 9.

As illustrated in FIG. 9, for example, the IP address of the printer is 192.168.10.5 (subnet mask: 255.255.255.0), the IP address of a client A is 192.168.10.10 (subnet mask: 255.255.255.0), and the IP address of a client B is 192.169.30.8 (subnet mask: 255.255.255.0).

These apparatuses have the same network address (192.168) set by the subnet mask. The host address (10.5) of the printer and the host address (10.10) of the client A are the same to each other, but are different from the host address (30.8) of the client B. If the printer and the client A have the same host address in this way, the two apparatuses are determined to be present within the same network segment. The client B having the different host address is determined to be present in a different network segment.

If it is determined in S62 illustrated in FIG. 8 that the client 202 is not present in the same network segment as that of the printer 206, it is likely that the printer 206 is remotely placed from the client 202 by a considerably long distance. To assure security, the standard print job is transmitted to the spool server 204 to be handled as an authentication print job. The standard print job from the client B illustrated in FIG. 9 is handled in this way.

Information (such as an apparatus name or a geographical name) other than the IP address may be used as the identification information of the job transmission source. Determination content derived from the identification information is not only a determination as to whether the client 202 is within the same network segment as the printer 206, but also a determination relating to the environment. For example, a determination is made as to whether the apparatus is within a predetermined network segment (different from the network segment of the printer 206), or whether the apparatus name or the geographic name is a particular name.

If it is determined in S62 in FIG. 8 that the apparatus is within the same network segment, the printer 206 acquires information regarding the installation location of the client 202 (S63). On the basis of the acquired information, the printer 206 determines whether a distance between the installation location of the client 202 and the installation location of the printer 206 falls within a predetermined distance range, for example, within 5 m (S64).

The determination regarding the installation location is described with reference to FIG. 10.

Referring to FIG. 10, the authentication printing system 100 or any other appropriate device, such as the spool server 204, pre-stores installation location information of each apparatus, such as the client 202 and the printer 206, for example, in the form of a room number or installation coordinates. The printer 206 thus determines whether the distance of the printer 206 to each apparatus falls within a constant distance range.

Referring to FIG. 10, a client A is 3.6 m apart from a printer X, and the distance therebetween is determined to be shorter than 5 m. A client B is 9.4 m apart from the printer X, and the distance therebetween is determined to be longer than 5 m. A client C has a different room number and is installed in a room different from that of printer X. The distance therebetween is determined to be longer than 5 m.

If it is determined in the installation location determination in S64 illustrated in FIG. 8 that the distance between the client 202 and the printer 206 is longer than 5 m, it is expected to take time to retrieve printed matter. The printer 206 transmits the standard print job from the client 202 to the spool server 204 to handle the standard print job as an authentication print job (S75).

On the other hand, if it is determined in S64 that the distance between the client 202 and the printer 206 is within 5 m, the printer 206 checks the mounting status of each optional device (attachment device) (S65). On the basis of the check results, the printer 206 determines whether a keyed bin is mounted (S66). The keyed bin refers to a discharge tray into which printed matter is discharged. The bin is normally locked so that the printed matter is not taken out. The bin is unlocked using a key or when the user is successfully authenticated. If such a bin is mounted, secret printed matter is less likely to be exposed to a third party.

If the check results show that the keyed bin is not mounted, the standard print job is transmitted to the spool server 204 as an authentication print job (S75) in order to reduce the possibility that the printed matter is carried away by a third party.

If it is determined that the keyed bin is mounted, the printer 206 then determines whether the bin is empty (not busy with another print job) (S67).

If the bin is not empty, the standard print job is transmitted to the spool server 204 in the same manner as when the keyed bin is not mounted (S75).

On the other hand, if it is determined in S67 that the bin is empty, the printer 206 acquires the attribute information of the print job from the print job header (S68). The printer 206 references an authentication print history (stored in S57 of FIG. 7), and searches for the attribute information in the authentication print history common to the acquired attribute information. The printer 206 thus determines whether there is a history that a print job common in attribute information to the standard print job has been handled as an authentication print job (S69).

As previously discussed, the attribute information may contain the user ID, the document name, the print data encryption instruction, the print watermark instruction, and/or time and date of printing.

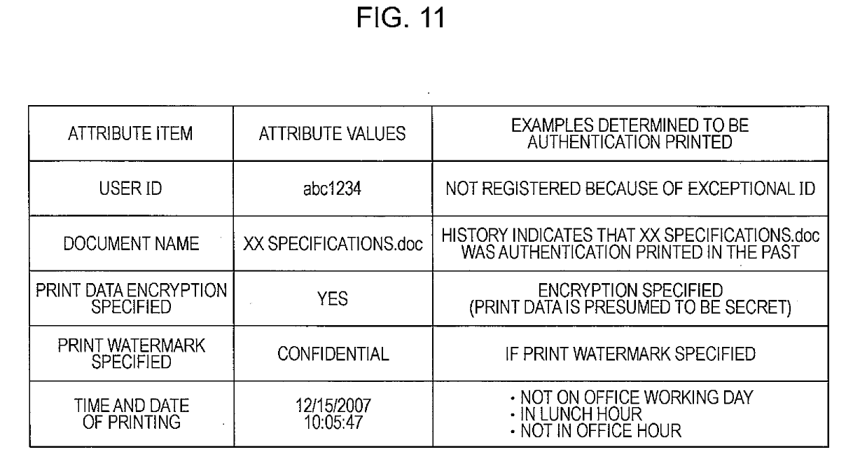

A determination process performed based on the attribute information and the authentication print history of the print job is described below with reference to FIG. 11.

Referring to FIG. 11, the user ID in the attribute information is checked against the user ID in the authentication print history. If it is determined that the same user ID has already been registered in the authentication print history, the standard print job is to be handled as an authentication print job.

The document name of the standard print job in the attribute information is checked against the authentication print history. If the same document name (or a document name having the same character string as the standard print job) is registered in the authentication print history, that standard print job is handled as an authentication print job.

If there is a history indicating that a print job having the same attribute information as the standard print job has been handled as an authentication print job, the printer 206 transmits the standard print job to the spool server 204 (S75).

On the other hand, if the print job attribute information is not such information, the printer 206 extracts (generates) a print image (image information) from the print job (S70), checks the extracted print image and the above-described print job attribute information against a inhibition rule database (S71) to determine whether the print image and the print job attribute information falls within or outside inhibition data (S72).

The inhibition rule database contains attribute information of a print job that is typically not to be handled as a standard print job, and particular character data or particular image data contained in a print image (hereinafter referred to as inhibition data).

The inhibition data may contain a character string or an image extracted from a print job handled as an authentication print job in the past (for example, a name, an address, and a telephone number of a person), a particular character or image predetermined by a person (for example, “secret from outsiders” or “confidential”), a quantitative threshold value applied to the number of such character strings or such images in a manner such that if the character strings or images above the quantitative threshold value are present, the standard print job is to be handled as an authentication print job, or a particular condition defined by a person (an encryption instruction, time and date of printing outside office hours, in lunch hour, outside standard office hours).

More specifically, if a character string or an image within the range of the inhibition data is contained in the print image extracted from the print job, the standard print job may be to be handled as an authentication print job.

Referring to FIG. 11, a character string within the range of the inhibition data is contained in a document name contained in the attribute information of the standard print job, the standard print job may be to be handled as an authentication print job.

If an encryption instruction is contained in the print job attribute information, the print job is presumed to contain information to be kept secret. The standard print job is thus determined to be handled as an authentication print job.

If the print job attribute information contains a print watermark instruction of a character string or an image corresponding to the inhibition data such as “confidential” is contained in the print job attribute information, the print job is presumed to contain information to be kept secret. The standard print job is thus determined to be handled as an authentication print job.

If the time and date of printing represented by the print job attribute information is within the range of the inhibition data, for example, the time and date is not in the office hours, is in lunch hour, or is outside the standard operation hours, there is a risk that the printed matter is carried away. The standard print job is thus determined to be handled as an authentication print job.

If data within the range of the inhibition data is contained in the print job attribute information or the print image, the printer 206 transmits to the spool server 204 the standard print job as an authentication print job (S74).

If the print job attribute information and the print image is outside the range of the inhibition data, the printer 206 performs the print output operation of the standard print job that has passed the above-described tests (S73), transmits the determination results to the client 202 (S75), and then ends the process.

The modification of the print setting performed by the client 202 is specifically described.

The method of modifying the print setting may be changed depending on the reason why the standard print job is handled as an authentication print job. For example, the standard print job may be handled as an authentication print job because the network segment is different from that of the printer, because the installation location of the printer is spaced apart by a predetermined distance or longer, because the print watermark instruction or the print data encryption instruction is contained, etc.

In the case of different networks, the IP address of a print job destination may be changed to an IP address of the spool server, a print type default setting on a screen of the printer driver is changed from the standard print job to the authentication print job, or the IP address of the print job destination may be changed to an IP address of a printer within the same network segment as that of the client.

If the installation location of the printer is spaced apart from the installation location of the print instruction client by a predetermined distance or longer, the IP address of a print job destination may be changed to an IP address of the spool server, a print type default setting on a screen of the printer driver is changed from the standard print job to the authentication print job, or the IP address of the print job destination may be modified to an IP address of a printer within a predetermined distance range of the client.

The setting modification may be performed if an inhibition character string or a watermark insertion on an image is contained. For example, the IP address of a print job destination may be changed to an IP address of the spool server, or a print type default setting on a screen of the printer driver is changed from the standard print job to the authentication print job (particularly if “watermark authentication print” is selectable, the watermark authentication print is defaulted).

The setting modification may be performed if the print data encryption is designated. For example, a print type default setting on a screen of the printer driver is changed from the standard print job to the authentication print job (particularly if “encryption data authentication print” is selectable, the encryption data authentication print is defaulted).

In accordance with the authentication printing system 100 of the present embodiment, even if the user mistakenly selects the standard print job for the standard print job, the print execution decision section 106 in the printer 206 determines whether to execute the print output operation. If the print execution decision section 106 determines that the print job should not be handled as a standard print job, the standard print job is transmitted to the spool server 204 to be handled as an authentication print job. Information security is thus increased.

In accordance with at least one determination condition related to the necessity of information protection, the standard print job output from the job transmission source is automatically handled as an authentication print job. The standard print job is printed in front of the user who has been authenticated. This arrangement reduces the possibility of information leaks from the printed matter.

The embodiment of the invention has been discussed for exemplary purposes only. The scope of the invention is not limited to the embodiment. Changes and modifications are possible without departing from the scope of the invention.

A determination as to whether a function of the printer of handling the authentication print job is effective (as to whether such a function is mounted, and as to whether such a function, if mounted, is enabled) is determined, for example. If the function is effective, all the received standard print jobs are handled as an authentication print job (transmitted to the spool server) without executing a complex determination such as the one of FIG. 8. The invention is also applicable to a system in which the authentication print job is stored within the printer rather than being stored on the spool server different from the printer.

The entire disclosure of Japanese Patent Application No. 2008-63630, filed Mar. 13, 2008 is expressly incorporated by reference herein.

What is claimed is:

1. An authentication output apparatus, connected to a job storage device for communication, performing an output operation for outputting an authentication output job and a standard output job, the job storage device storing the authentication output job, the authentication output apparatus performing the output operation by reading from the job storage device the authentication output job relating to a user upon the user being authenticated, the authentication output apparatus comprising:
a job receiver that receives the standard output job;
a job transferring unit that transfers the received standard output job to the job storage device;
an output instruction unit that reads from the job storage device the standard output job related to the user upon the user being authenticated; and
an output executing unit that performs the output operation to output the read standard output job.

2. The authentication output apparatus according to claim 1, further comprising an output process decision unit, wherein the output process decision unit determines whether at least one condition is satisfied, and, in response to the determination results, selects between supplying the received standard output job to the job transferring unit to transfer the received standard output job to the job storage device and supplying the received standard output job to the output executing unit to perform the output operation.

3. The authentication output apparatus according to claim 2, wherein the output process decision unit acquires identification information regarding a transmission source device of the received standard output job, and determines based on the acquired identification information whether the predetermined condition is satisfied.

4. The authentication output apparatus according to claim 3, wherein one of the predetermined conditions is that an address of the transmission source device is within a predetermined network segment.

5. The authentication output apparatus according to claim 2, wherein the output process decision unit pre-stores at least one piece of particular character information or one piece of particular image information, extracts character information or image information contained in an output image of the received standard output job, and in one of the predetermined conditions determines whether the extracted character information or the extracted image information corresponds to the pre-stored particular character information or the pre-stored particular image information.

6. The authentication output apparatus according to claim 2, wherein the output process decision unit acquires position information of the transmission source device of the received standard output job, and, on the basis of the acquired position information, determines in one of the predetermined conditions whether the position of the transmission source device is within a predetermined positional area.

7. The authentication output apparatus according to claim 2, wherein the output process decision unit acquires attribute information of the received standard output job, and determines on the basis of the acquired attribute information whether the predetermined condition is satisfied.

8. The authentication output apparatus according to claim 7, wherein the output process decision unit pre-stores at least one piece of particular attribute information, and determines as one of the predetermined conditions whether the acquired attribute information corresponds to any of the pre-stored particular attribute information.

9. The authentication output apparatus according to claim 7, wherein the output process decision unit stores a history of attribute information of a past job of the output operation performed in response to the user being authenticated, and checks the acquired attribute information against the attribute information within the stored history in order to determine whether the predetermined condition is satisfied.

10. The authentication output apparatus according to claim 9, wherein the output process decision unit accesses a remote history that is a record of attribute information of a past job of the output operation performed in response to another authentication output apparatus having authenticated the user, and checks the acquired attribute information against the accessed remote history in order to determine whether the predetermined condition is satisfied.

11. The authentication output apparatus according to claim 1, wherein, upon failing to transfer the received standard output job to the job storage device, the job transferring unit detects a second job storage device, and then transfers the received standard output job to the second job storage device.

12. An authentication printing system comprising:
the authentication output apparatus according to claim 1;
the job storage device that stores the authentication output job and the standard print job transferred from the authentication output apparatus; and
a job transmission source device that transmits the authentication output job and the standard output job.

13. An authentication output method of an output operation for outputting an authentication output job and a standard output job, comprising:
determining whether at least one predetermined condition is satisfied;
receiving the job;
if the received job is the authentication output job, storing the authentication output job with the output operation of the authentication output job temporarily suspended;
if the received job is the standard output job, selecting in response to the determining of the predetermining condition between performing the output operation of the received standard output job and storing the received standard output job with the output operation of the received standard output job temporarily suspended; and
if a user is successfully authenticated, performing the output operation of the job stored and related to the user.
